(19) United States
(12) Patent Application Publication
(10) Pub. No.: US 2005/0179623 A1
(43) Pub. Date: Aug. 18, 2005

(54) Driver for non-linear displays comprising a random access memory for static content

(75) Inventor: Andy Catalin Negoi, Adliswil (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/513,098

(22) PCT Filed: Apr. 29, 2003
(86) PCT No.: PCT/IB03/01644

(30) Foreign Application Priority Data
May 2, 2002 (EP) 02009864.6

(51) Int. Cl. G09G 3/30

(52) U.S. Cl. 345/76

(57) ABSTRACT

Driver system (10) for use in connection with a non-linear display array having N×M pixels. The driver system (10) comprises an input for receiving column data representing an image to be displayed, and a row driver designed to sequentially collect the currents of all M pixels of each row of pixels row electrode by row electrode. A gamma correction unit (17) is employed that provides for a gamma correction of the column data. The gamma correction unit (17) is situated at the input side of a display data memory (14) for storing the gamma corrected column data. The driver system (10) further comprises a column driver (24) designed to apply column signals to all M column electrodes in parallel, the column signals being generated in accordance with the gamma corrected column data.

The present invention relates to non-linear display systems, such as polymer light emitting displays that require a random access memory for storing static image content, and in particular drivers for displays of this kind.

With the widely divergent use of electronic devices comprising displays, for instance laptop computers and mobile phones, various display technologies have been employed, for example liquid crystal displays (LCD), light emitting diode (LED) displays, and more recently organic light emitting (OLED) displays.

Cathode ray tubes (CRT) and thin film transistor (TFT) matrix displays are further examples of display technologies widely used. Since CRT and TFT displays have a non-linear characteristic, a gamma correction is performed in order to adjust the image being displayed accordingly. These displays are mostly employed in devices where the display content changes dynamically and there is thus no need for a display data memory.

The OLED technology holds promise because of its ability to efficiently address a very wide range of colors, while operating at extremely low power. As a result, this technology is expected to be brighter, lower in cost, consume less power (which is an advantage if used in portable electronic devices which depend on a battery as a power source), afford wider viewing angles, and be extremely lightweight. OLEDs are thus ideal for today's mobile device applications. Moreover, this technology will be also ideal for a variety of lighting conditions and capable of running at fill speeds in extreme temperatures.

Polymer light emitting diodes (PolyLED), a segment of the total OLED market, will be a key display technology in the future, especially in color mobile applications.

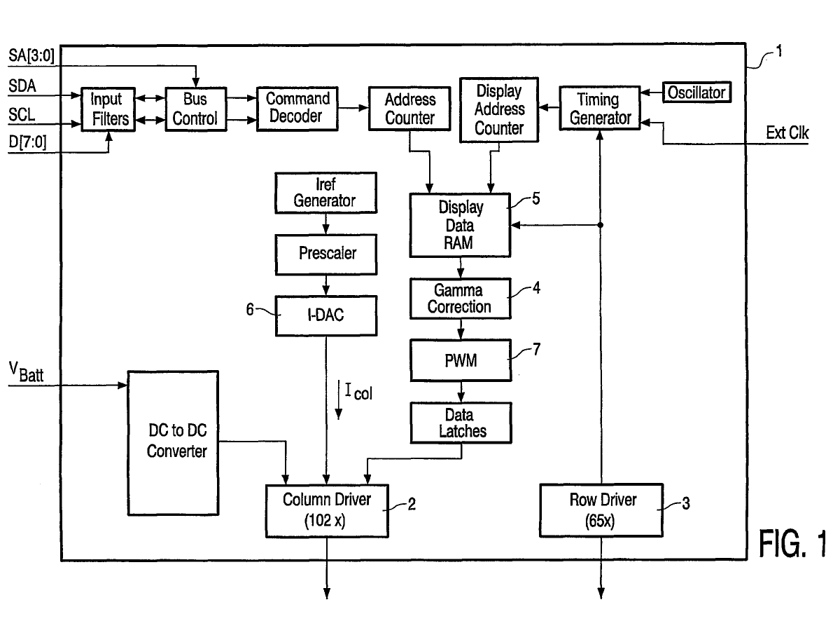

Some of the essential parts of a conventional matrix driver 1 are illustrated in FIG. 1. The driver 1 is a single chip driver that can be used for driving a passive-matrix PolyLED display featuring N=64 rows and M=102 columns, i.e. 64×102 pixels. The driver 1 comprises column driver means 2 and row driver means 3. The current to be supplied to the light emitting diodes of the PolyLED display is furnished by a DAC 6 (digital-to-analog converter) that converts a number received from an interface into an appropriate intensity of a current Icol. This current Icol will be mirrored via the column driver 2 to the columns of the PolyLED display. The row driver means 3 collect the currents of the anodes of the light emitting diodes of a whole row. The column driver means 2 are current sources. Means 4 for gamma correction are provided at an output side of the display data memory 5. Different grey levels can be obtained using the PWM unit 7.

The power consumption of current display drivers for use in connection with non-linear displays is still an issue, and there is a demand for display devices consuming even less power than conventional ones.

It is an object of the present invention to provide an improved driver for a non-linear display and to provide an improved non-linear display device.

It is an object of the present invention to provide a driver for non-linear display, e.g. an electroluminescent display, that consumes less power than a conventional driver.

These and other objects are achieved by the present invention, which provides a driver system for use in connection with a non-linear display array. The driver system comprises a row driver designed to sequentially collect row-by-row the currents of the pixels of a row. This is done by applying a row select signal to the N row electrodes to scan one row after the other. A gamma correction unit is employed for performing a gamma correction of column data representing an image to be displayed. The gamma corrected column data are stored in a display data memory. The driver system comprises a column driver designed to apply column signals to the M column electrodes in parallel, the column signals being generated in accordance with the gamma corrected column data.

Also provided is a non-linear display (for example a passive matrix N×M polymer light emitting diode array) comprising a driver system.

These and other aspects of the invention will be apparent from and elucidated with reference to the embodiment(s) described hereinafter.

For a more complete description of the present invention and for further objects and advantages thereof, reference is made to the following description, taken in conjunction with the accompanying drawings, in which:

FIG. 1 is a schematic block diagram of a conventional matrix driver that can be used for driving a PolyLED display;

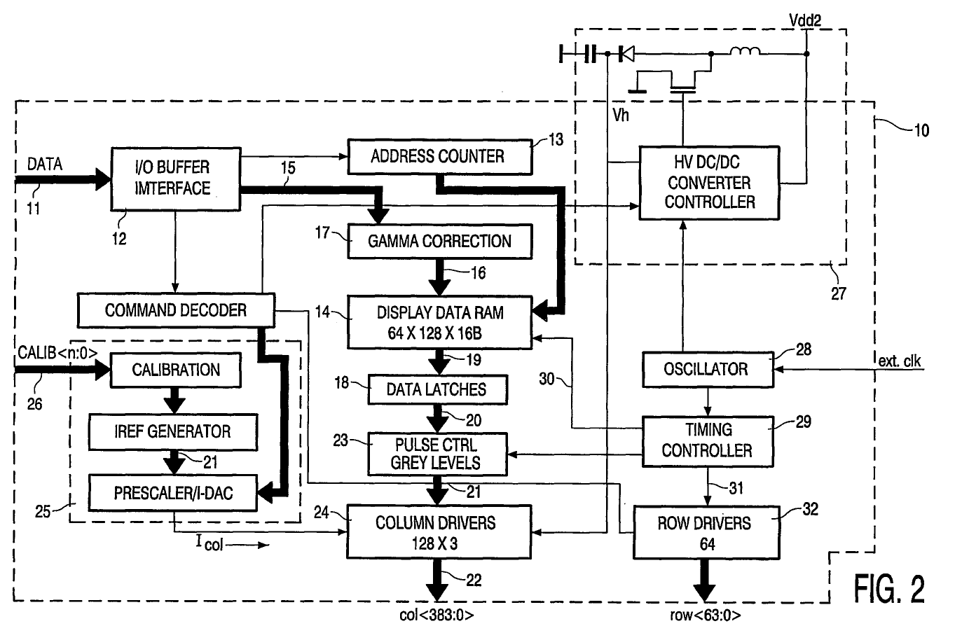

FIG. 2 is a schematic block diagram of a matrix driver, according to the present invention that can be used for driving a PolyLED display;

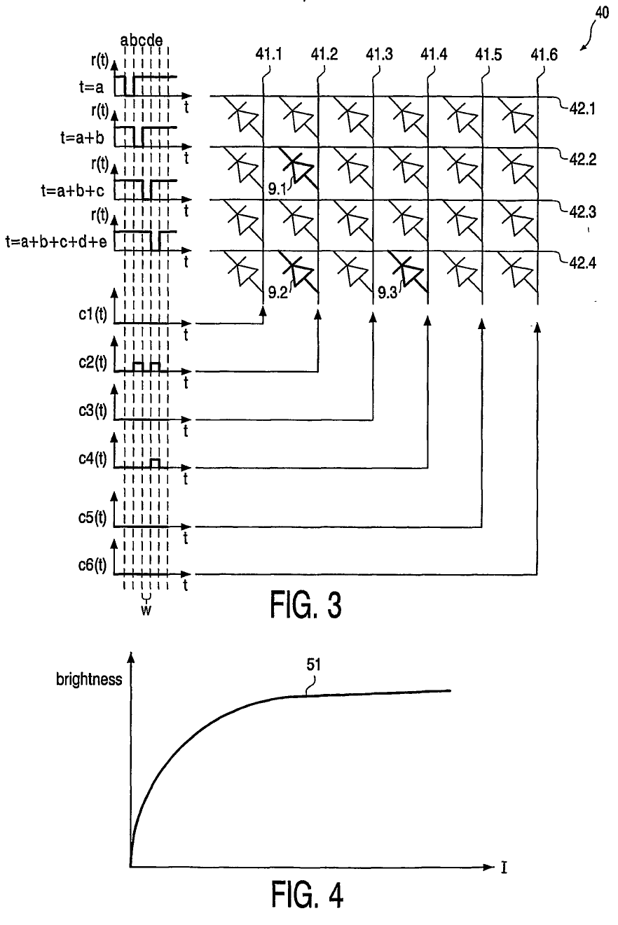

FIG. 3 is a schematic block diagram of a PolyLED display;

FIG. 4 is a graph showing a brightness versus current curve of a PolyLED display;

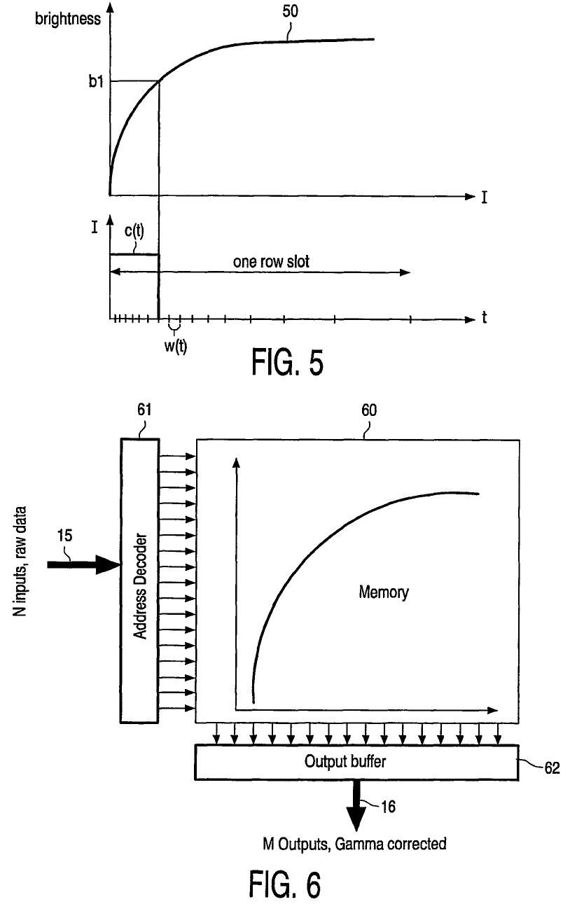

FIG. 5 is a graph showing a brightness versus current curve of a PolyLED display and a segmentation of a row slot according to the present invention;

FIG. 6 is a schematic diagram showing a gamma correction unit, according to the present invention.

The present invention is described in connection with several embodiments. In the following sections mainly polymer OLED (PolyLED) color display are being addressed. The invention, however, is also applicable to any other type of non-linear display array.

A driver 10 in accordance with the present invention is illustrated in FIG. 2. The driver 10 can be used for driving a passive-matrix polymer OLED (PolyLED) color display that features N=64 rows and M=128×3 columns, i.e. 64×128×3 pixels (note that three green, red, blue sub-pixels form one pixel). Such an OLED display may comprise a series of emissive polymer-based thin films sandwiched between two electrodes, one of which is transparent (most often glass). The thin films define a matrix of N×M light emitting diodes, each light emitting diode having an anode and a cathode.

An example of a monochrome PolyLED display 40 is depicted in FIG. 3. Only a few pixels are shown in FIG. 3 for the sake simplicity. In practice, there may be several hundred rows and columns of pixels. The display 40 comprises N=4 rows 42.1 through 42.4 and M=6 columns 41.1 through 41.6. There are N×M light emitting diodes arranged in a matrix with N=4 rows and M=6 columns, so that the anodes of all the light emitting diodes of the first row connect to the respective row electrode 42.1, all the light emitting diodes of the second row connect to the respective row electrode 42.2, and so forth. The cathodes of all light emitting diodes of the first column connect to the respective column electrode 41.1, the cathodes of all light emitting diodes of the second column connect to the respective column electrode 41.2, and so forth. In operation, each row of light emitting diodes is sequentially activated via the corresponding row electrode 42.1-42.4, where the individual light emitting diodes are activated using the corresponding column electrodes 41.1-41.6. A light emitting diode emits light if its cathode is at 3.3 volts, for example, and its anode at the same time is at 0 volt, since the diodes are reverse biased. In other words, as long as a positive voltage is applied to a row electrode 42.1-42.4, none of the diodes connected to this particular row electrode can be activated, no matter what column signals are being applied to the column electrodes 41.1-41.6. On the left hand side of FIG. 3, the timing of the row select signal r(t) and the column signals c1(t)-c6(t) is depicted. For the sake of simplicity, only two column signals c2(t) and c4(t) actually show pulses. In the given example all other column signals c1(t), c3(t), c5(t), and c6(t) are at zero volt. The column signal c1(t) is applied to the column electrode 41.1, the column signal c2(t) is applied to the column electrode 41.2, and so forth, as illustrated in FIG. 3. During a first time slot a, the row select signal r(t) is pulled to zero while being applied to the first row electrode 42.1. Since during this time slot a none of the column signals c1(t)-c6(t) is at 3.3 volts, all light emitting diodes of the first row remain dark. During the time slot b the row select signal r(t) is at 0 volt while being applied to the second row electrode 42.2. At the same time the column signal c2(t) is at 3.3 volts. This constellation of signals causes a current to flow through the light emitting diode 9.1 in row two and this diode 9.1 emits light. No other diode of the same row 42.2 emits light since only the signal c2(t) is at 3.3 volts in the given example. During a third time slot c, the row select signal r(t) is pulled to zero while being applied to the third row electrode 42.3. Since during this time slot c none of the column signals c1(t)-c6(t) is at 3.3 volts, all light emitting diodes of the third row remain dark. During the time slot d the row select signal r(t) is at 0 volt while being applied to the fourth row electrode 42.4. At the same time the column signals c2(t) and c4(t) are at 3.3 volts. This constellation of signals causes currents to flow through the light emitting diode 9.2 in row two and the light emitting diode 9.3 in row four. The two diodes 9.2 and 9.3 emit light. Since the scanning of all rows 42.1 through 42.4 is done quickly, the human eye perceives all three diodes 9.1, 9.2, and 9.3 to be turned on at the same time while all other diodes remain dark. All three diodes 9.1, 9.2, and 9.3 shine during one whole slot length w, i.e. all three diodes 9.1, 9.2, and 9.3 emit at the maximum brightness.

The driver 10, as illustrated in FIG. 2, is designed to drive the row electrodes 42.1-42.4 and column electrodes 41.1-41.6 accordingly. The column data representing an image to be displayed on a display 40 is fed from a host, for example via a data link 11 and a buffer interface 12 to the driver 10. The buffer interface 12 transforms the serial column data into parallel column data. An address counter 13 is employed in order to be able to write the column data byte-by-byte into a display data memory 14. A random access memory (RAM) is used as display data memory 14. The RAM 14 has a capacity of 64×128×16 bits, since in the present example the column data are coded on 16 bits (6 bits green, 5 bits red, 5 bits blue).

In the present example, the buses 15 and 16 are 16 bits wide. According to the present invention, a gamma correction unit 17 is employed. This unit 17 is situated in front of the display data memory 14 and is designed to transform the column data received via bus 15 into column data that take into consideration the non-linear behavior of the light emitting diodes of the PolyLED display 40. Such a gamma correction is necessary since the relationship between the current fed through a diode and the brightness of the light emitted by the diode is non-linear. An exemplary current versus brightness curve is given in FIG. 4. This curve illustrates the non-linearity of the display 40. According to the present invention, the column data stored in the RAM 14 are corrected for each color (green, red, blue). Data that have been processed by the gamma correction unit 17 are herein referred to as gamma corrected column data.

These gamma corrected data are then fed via the bus 16 into the memory 14. Optionally, data latches 18 are employed at the output of the memory 14 to keep the gamma corrected column data for a short period of time. The gamma corrected column data are forwarded in several steps via the buses 19, 20, and 21 and the units 18 (optional) and 23 to a column driver 24. The buses 19 to 22 are 128×3 bit wide. A pulse control unit 23 is situated at the output side of the RAM 14. This unit 23 transforms the data representing the three colors green, red and blue into corresponding grey levels. This may be done by controlling the length w of the column signals c1(t)-c6(t), for example. By doing so, the time a row is selected (active) and is divided into small slots which may be a fraction of the slot lengths depicted in FIG. 3 as a, b, c, d, and e. These small slots may be of equal or unequal lengths.

There is a column driver 24 comprising switches (for example MOS transistors or bipolar transistors). These switches are employed to switch a current Icol received from a current source 25. It is possible to calibrate the current Icol via the input 26. Other than an LCD display which is driven with voltage levels, the PolyLED display 40 is driven with constant currents. An example of a switch suitable for use in connection with the present invention is described in the PCT-patent application WO 99/65012, as published on 16 Dec. 1999. This PCT-patent application is currently assigned to the assignee of the present application.

A converter block 27 in provided for up- or down-conversion of the supply voltage Vdd2 to the voltage Vh needed by the display 40 (in the present example, Vh=3.3 volts). The supply voltage Vdd2 may be provided by a battery. An oscillator 28, for example an RC-oscillator, provides the timing signal needed by a timing controller 29. The timing controller 29 synchronizes the column signals c1(t)-c6(t) and the row select signal r(t). For this purpose, the timing controller 29 is connected via links 30 and 31 to the RAM 14 and the row driver 32, respectively. The row driver 32 comprises switches (for example MOS transistors or bipolar transistors) that connect to the row electrodes of the display 40.

It is an advantage of the present invention that gamma correction of incoming column data is only needed when the image on the display 40 changes.

According to the present invention, a gamma correction unit 17 is, for example, a logic block implementing a non-linear function. Its input received via the bus 15 is a number represented with N bits (for example N=16) for a pixel color content. The output at the bus 16 is a number represented on M bits (for example M=18) where M may or may not be equal to N. The output number M sets the exact length of the current pulse, created by the pulse control unit 23. The pulse control unit 23 is fixed (wired-up), whereas the gamma correction unit 17, according to the present invention, allows a certain degree of programmability, either to adapt to a specific electroluminescent material or to cope with the material's efficiency degradation in time.

In detail, the gamma correction unit 17 may be, in a preferred embodiment, a look-up table, but not exclusively: any digital processing unit with an N-bit number as input and an M-bit number as output and mimicking the non-linear characteristic of the display (cf. FIG. 4) might be used. An example of an embodiment of a gamma correction unit 60 is illustrated in FIG. 6. The gamma correction unit 60 comprises an input buffer 61 and an output buffer 62. The input buffer 61 receives via the bus 15 a number represented with N bits (raw column data). After gamma correction, the output buffer 62 provides gamma corrected data at the output bus 16, the data being represented on M bits. The curve inside the box 60 in FIG. 6 represents the non-linearity that is to be corrected by means of the gamma correction unit 60.

In a preferred embodiment of the present invention, the gamma correction unit 17 comprises a look-up table. The column data can be converted while being written into the RAM 14. The advantage is that this look-up table is addressed while the column data are being transferred or changed only if a change is necessary. Otherwise the content of the RAM 14 remains static. As long as the image on the display 40 remains static, no gamma correction needs to be performed. The gamma correction is only carried out when new column data are received via the input 1, and not during each time slot, as in a conventional driver illustrated in FIG. 1.

The inventive approach saves computing logic, time and power, since each gamma correction would consume power.

Another embodiment is characterized in that a timing generator is employed that generates unevenly distributed time slots w(t). An example of a current vs. brightness curve 50 is depicted in FIG. 5. Below this curve 50, the distribution of the time slots is plotted in a time vs. current diagram. The various lengths w(t) of these time slots have to be taken into consideration when performing the gamma correction. In this case, a connection between the timing generator and the gamma correction unit is required. The distribution of the slots w(t) is chosen such that for the steep part of the curve 50 there are many short slots w(t), whereas for the flat part of the curve there are fewer but longer slots w(t). A column signal c(t) is shown in FIG. 5. This signal c(t) is seven slots wide in the given example. The width of this signal c(t) results in a brightness b1. A signal c(t) whose width is equal to the length of a row slot would result in the maximum available brightness.

In another embodiment, a separate unit is provided before the display data memory in order to provide for a compensation of the degradation of the light emitting diodes. There is a correlation between the current flowing through the individual diodes and their efficiency. An analytical expression of the relationship of the current vs. light output may be used to determine an additional charge to be injected into a particular LED for it to maintain a (substantially) constant light output. A look-up table, preferably a table sampled in time, may be comprised in the separate unit in order to account for this degradation before storing the column data in the display data memory.

The driver according to the present invention offers an integrated DC-DC converter and oscillator, multiple serial and parallel high-speed bus interfaces, and an integrated gamma correction solution that is fast and efficient.

Drivers in accordance with the present invention can be used in small-scale mobile applications including cellular phones, pagers, digital cameras, PDAs, and so forth.

It is appreciated that various features of the invention, which are, for clarity, described in the context of separate embodiments may also be provided in combination in a single embodiment. Conversely, various features of the invention which are, for brevity, described in the context of a single embodiment may also be provided separately or in any suitable subcombination.

In the drawings and specification there have been set forth preferred embodiments of the invention and, although specific terms are used, the description thus given uses terminology in a generic and descriptive sense only and not for purposes of limitation.

1. Driver system for use in connection with a non-linear display array having N×M pixels, the driver system comprising
an input for receiving column data representing an image to be displayed,
a row driver designed to sequentially collect the currents of all M pixels of each row of pixels row electrode by row electrode, by applying a row select signal to the N row electrodes so as to scan the rows of pixels one after the other,
a gamma correction unit providing for a gamma correction of the column data,
a display data memory for storing gamma corrected column data,
a column driver designed to apply column signals to all M column electrodes in parallel, the column signals being generated in accordance with the gamma corrected column data.

2. Driver system of claim 1, wherein the non-linear display array is a polymer light emitting display comprising
N row electrodes,
M column electrodes, and
N×M light emitting diodes, each light emitting diode having an anode and a cathode, the light emitting diodes being arranged in N rows and M columns.

3. Driver system of claim 1, wherein various grey levels are obtained by employing row select signals and/or column signals having pulses of different pulse length.

4. Driver system according to claim 1, wherein the gamma correction unit comprises a look-up table.

5. Driver system according to claim 4, wherein entries in the look-up table take into consideration the non-linearity of the non-linear display arrays.

6. Driver system according to claim 4 in combination with claim 2, wherein entries in the look-up table take into consideration the non-linear brightness versus current characteristics of the light emitting diodes and the sensitivity of the human eye.

7. Driver system according to claim 3, wherein the light emitting diodes are arranged so that the anodes of M out of the N×M light emitting diodes connect to one of the N row electrodes whereas each of the cathodes of said M out of the N×M light emitting diodes connects to a different one of the M column electrodes.

8. Driver system according to one of the preceding claims, further comprising a pulse control unit which renders it possible to display different grey levels on the display.

9. Driver system according to one of the claim 1, wherein the gamma correction unit comprises a logic block implementing a non-linear function.

10. Nonlinear display array comprising a driver system according to one of the claim 1.

11. Polymer light emitting diode array comprising a driver system according to one of the claim 1.
